(19) United States
(12) Patent Application Publication
(10) Pub. No.: US 2018/0163775 A1
(43) Pub. Date: Jun. 14, 2018

(54) BALL JOINT

(71) Applicant: ZF Friedrichshafen AG, Friedrichshafen (DE)

(72) Inventors: Jürgen GRÄBER, Stemwede (DE); Harold HOPKINSON, Farmington Hills, MI (US); Wolfgang EULERICH, Osnabrück (DE)

(21) Appl. No.: 15/736,398

(22) PCT Filed: May 17, 2016
(86) PCT No.: PCT/EP2016/060962

§ 371 Date: Dec. 14, 2017

(30) Foreign Application Priority Data
Jun. 16, 2015 (DE) 10 2015 211 005.2

(51) Int. Cl. F16C 11/06

(52) U.S. Cl. CPC F16C 11/0638; F16C 11/0657; F16C 11/069

(57) ABSTRACT

A ball joint having a housing, an opening and an inner circumferential surface facing the opening and extending around a longitudinal axis. The housing holds a ball socket that opens toward the opening and has an overlap region that is inclined radially inward, in the direction of the opening, and which, with the circumferential surface, delimits an annular space. A ball pin having a joint ball is mounted in the socket and extends out of the housing through the opening. A locking ring is inserted into the annular space and fixed axially between the socket and an inner shoulder located adjacent the opening. An outer circumferential surface of the locking ring abuts the circumferential surface and a surface which abuts an area of the overlap region and which is inclined inwardly toward the longitudinal axis in the direction of the pin opening. The locking ring is an open ring.

This application is a National Stage completion of PCT/EP2016/060962 filed May 17, 2016, which claims priority from German patent application serial no. 10 2015 211 005.2 filed Jun. 16, 2015.

### FIELD OF THE INVENTION

The invention concerns a ball joint with a housing having an inside space and a pin opening, the inside space having in an area facing toward the pin opening, an inner circumferential surface that extends around an axial central longitudinal axis, a ball socket which is arranged in the inside space and is open toward the pin opening, which socket has on its side facing toward the pin opening an overlap area which, in the direction of the pin opening, is inclined inward toward the central longitudinal axis and which, together with the inner circumferential surface of the housing, delimits an annular space, a ball pin with a joint ball which with its joint ball is fitted and able to move in the ball socket and extends through the pin opening out of the housing, and a locking ring inserted into the annular space and held in position between the ball socket and an inside shoulder of the housing formed in the area of the pin opening, which locking ring has an outer circumferential surface that rests against the inner circumferential surface of the housing and a contact surface that rests against a contact zone of the overlap area of the ball socket and is inclined inward relative to the central longitudinal axis in the direction toward the pin opening.

### BACKGROUND OF THE INVENTION

DE 100 05 979 A1 discloses a ball joint consisting of a joint housing open on at least one side, with a housing recess, a joint pin fitted into the housing recess with its joint ball which is provided with a surface protection, the pin section of which pin projects out of an opening of the housing, a bearing shell arranged between the joint housing and the joint ball, and a locking ring that clamps the bearing shell arranged in the joint housing into the latter, which ring, with its inner contour, essentially follows the outer contour of the bearing ring by virtue of a bevel or shaped radius, such that the locking ring to be inserted in the joint housing is fixed in position in the joint housing and on the side of the housing opening through which the pin section of the joint pin projects out of the housing, has a sealing lip that bears against the joint ball under elastic prestress.

In conventional ball joints, the loading or stressing is often not homogeneous. In such a case during peak loads some areas are more severely loaded than others, so the load-bearing ability of the joint is not used to the fullest. The causes of inhomogeneous loading may be, for example, manufacturing inaccuracies. For example, due to manufacturing inaccuracies the locking ring can bear against the ball socket but not the housing, or vice-versa.

### SUMMARY OF THE INVENTION

Starting from there, the purpose of the present invention is to be able to increase the load-bearing ability of ball joints.

This objective is achieve by a ball joint according to the independent claim. Preferred further developments of the ball joint are described in the subordinate claims and in the description given below.

The ball joint of the type mentioned at the start, with a housing having an inside space and a pin opening, the inside space having in an area facing toward the pin opening an inner circumferential surface, in particular cylindrical or conical, that extends around an axial central longitudinal axis, a ball socket arranged in the inside space and open toward the pin opening, which socket has on its side facing toward the pin opening an overlap area which in the direction of the pin opening is inclined inward toward the central longitudinal axis and together with the inner circumferential surface of the housing delimits an annular space, a ball pin having a joint ball, which with its joint ball is fitted and can move in the ball socket and which extends through the pin opening out of the housing, and a locking ring inserted into the annular space and held axially between the ball socket and an inner shoulder of the housing provided in the area of the piri opening, the ring having an outer circumferential surface, in particular cylindrical or conical, which rests against a contact zone of the overlap area of the ball socket and a contact surface inclined inward in the direction of the pin opening toward the central longitudinal axis, is further developed in that the locking ring is in the form of an open ring. In particular, the locking ring is arranged transversely to the central longitudinal axis between the ball socket and the housing.

The locking ring is pressed home into the annular space in the axial direction until it is in contact with both the inner circumferential surface of the housing and the overlap area of the ball socket. During this the locking ring is for example expanded or compressed, which is made possible by its open structure. Thus, manufacturing inaccuracies can be compensated.

The open locking ring has in particular a parting gap which preferably extends transversely to the central longitudinal axis and/or in the direction of the central longitudinal axis. Preferably, the parting gap lies in a plane that contains the central longitudinal axis. The parting gap can also be called a slit, so that the locking ring can also be called a ring with a slit or, simply, a split ring. The slit in the locking ring is or is preferably positioned perpendicularly to a principal loading direction of the ball joint and/or the ball socket. The locking ring is preferably rotationally symmetrical or substantially rotationally symmetrical relative to the central longitudinal axis. The expression “substantially rotationally symmetrical” takes into account the parting gap of the locking ring in particular.

The outer circumferential surface of the locking ring is preferably not in any form-fitting connection with the inner circumferential surface of the housing. The shaping required for example for such a form-fitting connection at the outer circumferential surface of the locking ring, as known for example from DE 100 05 979 A1, can interfere with the compensation of manufacturing inaccuracies. Preferably, the outer circumferential surface of the locking ring just rests in contact with the inner circumferential surface of the housing. Preferably, the outer circumferential surface of the locking ring and the inner circumferential surface of the housing are purely frictionally connected with one another. The inner circumferential surface of the housing is preferably cylindrical or conical, particularly in the area where the outer circumferential surface of the locking ring rests in contact with the inner circumferential surface of the housing and/or in the, or in one of the areas facing toward the pin opening. The outer cylindrical surface of the locking ring is preferably cylindrical or conical.

The ball socket preferably comprises a hollow ball-shaped fitting space in which, in particular, the joint ball is seated. Advantageously, in the overlap area of the ball socket, particularly centrally, a through-going aperture is provided through which the ball pin extends out of the ball socket. The central longitudinal axis extends in particular through the mid-point of the joint ball and/or through the mid-point of the hollow ball-shaped fitting space. The ball socket is for example in the form of a shaped shell. Preferably, the ball socket does not have a slit. Advantageously, the ball socket is rotationally symmetrical relative to the central longitudinal axis.

Cases may occur in which when the locking ring is being pressed home into the annular space, the ball socket is deformed in such manner that the joint ball gets stuck and/or jams in the ball socket. However, even slight deformations of the ball socket which do not yet lead to sticking and/or jamming of the joint ball can result in an inhomogeneous stress distribution in the ball socket. For that reason, after the locking ring has been fitted between the ball socket and the inner shoulder of the housing, the ball socket is preferably subjected to a tempering process. In this tempering process the ball socket is heated so that a homogeneous stress situation can be produced in the ball socket and/or stress inhomogeneities in the ball socket can be eliminated. Thus, in particular the ball socket undergoes a tempering process after the locking ring has been fitted between the ball socket and the inner shoulder of the housing.

The ball socket is preferably made of plastic, in particular a thermoplastic. For example, the ball socket is made of polyoxymethylene, polyamide, polyetheretherketone, polyphthalimide or polyetherimide.

The central longitudinal axis forms in particular the rotational axis of the inner circumferential surface of the housing. Thus, the inner circumferential surface of the housing preferably extends symmetrically around the central longitudinal axis. The housing is preferably made of metal, in particular steel.

The ball pin is preferably made of metal, in particular steel. Preferably, the ball pin forms a rotational body.

The locking ring preferably consists of metal, for example steel. Advantageously, the material of the locking ring is substantially more rigid than the material of the ball socket. In particular, the modulus of elasticity of the material of the locking ring is equal to or approximately equal to the elasticity modulus of the material of the housing. Preferably, the locking ring is and/or comes to be made from wire and/or a wire profile. This provided a particularly inexpensive way to produce the locking ring.

According to a further development, the thickness and/or the thickness profile of the ball socket is chosen such that under primary loading of the ball socket in a direction extending in particular transversely to the central longitudinal axis, the loading of the ball socket in the overlap area and/or the contact area is reduced. The above-mentioned direction in which the primary loading of the ball socket takes place can, for example, be called the principal loading direction. For the choice of a suitable thickness and/or a suitable thickness profile of the ball socket there are many options, which will be explained below and which can be realized both as stand-alone features and in combination.

Advantageously, in the overlap area and/or the contact area, the ball socket has a constant or approximately constant thickness along the central longitudinal axis in the, or in a principal loading direction. Preferably, the principal loading direction extends transversely to the central longitudinal axis.

In particular, along the central longitudinal axis in the overlap area and/or in the contact area the thickness of the ball socket transversely to the central longitudinal axis is constant or approximately constant.

Preferably, the thickness profile and/or thickness of the ball socket decreases, in particular continuously, with decreasing axial distance from the pin opening, and/or the thickness profile and/or thickness of the ball socket preferably increases, in particular continuously, from the equator of the ball socket down to the pole of the ball socket. This thickness of the ball socket preferably relates to the mid-point of the joint ball. Thus, the thickness can also be called the radial thickness, particularly when it relates to a spherical coordinate system with the mid-point of the joint ball as origin. The equator of the ball socket lies in particular in a plane extending transversely to the central longitudinal axis and passing through the mid-point of the joint ball, and preferably forms a major circle. The pole of the ball socket is in particular formed by the end area of the ball socket that is remote from the pin opening.

If the thickness of the ball socket in the overlap area is too large, the ball socket can become too soft there. In particular, the effective overlapping of the joint ball decreases with increasing thickness of the ball socket in the overlap area. Thus, the extraction forces required for pulling the ball pin in the axial direction out of the housing are reduced, which is disadvantageous. Accordingly, the thickness of the ball socket in the overlap area is preferably as small as possible. A small thickness of the ball socket in the overlap area increases the extraction forces required for pulling the ball pin in the axial direction out of the housing. Moreover, a small thickness of the ball socket saves space. However, the reduction of the ball socket thickness in the overlap area is limited since in the overlap area the ball socket should be thick enough to enable manufacturing inexactitudes to be compensated.

In a further development the locking ring has an opening surface facing toward the pin opening and inclined outward in the direction of the pin opening relative to the central longitudinal axis, this opening surface preferably being a free surface. This surface serves for example as a stop which limits the deflection of the ball pin. Moreover, when the locking ring is pressed into the housing the surface can be used as a counter-block.

The inner shoulder of the housing is preferably positioned outside a conical surface defined by the opening surface of the locking ring and/or a cone or solid angle defined by the opening surface of the locking ring. This ensures that the deflection of the ball pin is limited not by the inner shoulder but by the locking ring. In a possible limit case the inner rim of the inner shoulder ends in particular on or in the area of the conical surface and/or outside the cone or the solid angle and/or in the outer area of the cone or solid angle. The conical surface and/or the cone is in particular an imaginary conical surface and/or an imaginary cone.

On the side of the locking ring facing away from the pin opening, the outer circumferential surface of the locking ring preferably merges into the contact surface of the locking ring. This transition is preferably chamfered. On the side of the locking ring facing toward the pin opening, the outer circumferential surface of the locking ring preferably merges into the opening surface of the locking ring. This transition too is preferably chamfered. On the inner circumference of the locking ring facing toward the ball socket, the contact surface of the locking ring preferably merges into the opening surface of the locking ring. This transition is again preferably chamfered.

In cross-section, the locking ring is preferably of wedge-shaped and/or triangular form. The sides of the wedge-shaped cross-section are defined for example by the outer circumferential surface and by the contact surface of the locking ring. The sides of the triangular cross-section are defined for example by the outer circumferential surface, the contact surface and the opening surface of the locking ring. In particular, the outer circumferential surface and the contact surface of the locking ring enclose an acute angle.

The locking ring fills the annular space essentially completely. In cross-section the annular space is preferably wedge-shaped. The sides of the wedge-shaped cross-section are defined for example by the inner circumferential surface of the housing and by the overlap area and/or the contact zone of the ball socket. In particular, the inner circumferential surface of the housing and the overlap area and/or contact zone of the ball socket enclose an acute angle.

Preferably, the locking ring is supported on and/or with its side facing away from the pin opening, or end side, against the ball socket, particularly axially. Preferably, the locking ring is supported on and/or with its side facing away from the pin opening, or end side, against the housing, particularly axially, with interposition of the ball socket. Preferably the locking ring, on and/or with its side facing away from the pin opening, or end side, is not supported axially, or not directly, against the housing so that in particular the locking ring can be pressed or inserted far enough into the annular space. Preferably the locking ring, on and/or with its side facing away from the pin opening, or end side, does not rest axially, or not directly so, against the housing. The end side of the locking ring facing away from the pin opening is in particular an axial end side of the locking ring.

The ball socket is preferably clamped between the locking ring and the joint ball and/or the housing. However, it can happen that the ball socket is not sufficiently well secured against twisting. Preferably, on the contact surface of the locking ring, ridges and/or recesses are provided, which engage with the ball socket with interlock. These ridges and/or recesses can for example be in the form of knurling or in the form of corrugations and/or folds which, for example, are arranged close to the corrugations. Preferably, the ridges and/or recesses of the locking ring are a distance apart from one another in the circumferential direction. In particular, in the contact surface of the locking ring corrugations are provided and/or rolled in, into which the ball socket engages and/or is pressed. In this way the ball socket can be secured against twisting. Alternatively or in addition, ridges and/or recesses can also be provided in an area of the inside wall of the housing that is in contact with the ball socket, which features engage in one another with the ball socket in an interlocking manner. In the circumferential direction the ridges and/or recesses are preferably a distance apart from one another.

The invention provides in particular a ball joint in which the thickness profile of the ball socket is or comes to be designed such that when loaded in the principal direction transversely to the central longitudinal axis, the load on the opening side is reduced. If the ball socket on the side against the housing is too rigid, there is a risk that the loads on the smaller and weaker side will be increased even more. Thus, the rigidities in the two halves of the ball socket are preferably matched to one another. This happens in particular when the thickness profile of the ball socket in the direction of the central longitudinal axis decreases continuously from its equator toward its end facing the pin opening. The locking ring is used in order to support this outer contour in an optimum and inexpensive manner.

The locking ring preferably embodies one or more of the features indicated below, considered alone or in some combination:
embracing and supporting the ball socket up to the maximum possible point (the axial load-bearing capacity can be increased thereby);
full use of the space when the ball pin is at its maximum deflection (the rigidity of the ring can be increased thereby);
the locking ring fills the wedge-shaped annular space between the ball socket and the housing in an optimum manner. In particular, the locking ring transmits forces by compression, not by bending as with conventional flat rings;
the locking ring has a slit, so that it can adapt its diameter and fill the wedge-shaped space optimally (self-adjustment, i.e. optimum fit and tolerance compensation, since the dimensions of the ring are not fixedly determined; the residual gap can be positioned perpendicularly to the principal force direction and/or principal load direction);
the locking ring is small (i.e. in particular as thin-walled as possible), so that the housing can be made thicker and stronger;
the locking ring also transmits extraction forces by friction (almost self-locking) and thereby relieves the inner shoulder or rolled edge;
the locking ring is made by bending an inexpensive wire profile (other rings are stamped out or machined, during which material is wasted, which increases the price).

The locking ring preferably has a geometry by virtue of which the load-bearing capacity of the ball joint can be increased. For example, preferably on its contact surface the locking ring can even have a hollow contour or concave contour which, in particular, follows the outer contour of the ball socket. The inclination angle of the contact surface and/or the hollow contour can also be designed and optimized as necessary. Furthermore, the locking ring can be made inexpensively. When a wire profile is used to produce the locking ring, almost all of the material can be used.

The ball joint is preferably a ball joint for a motor vehicle. In particular, the ball joint is intended for use in a wheel or axle suspension of a motor vehicle. For example, the ball joint is a supporting joint. In particular the housing and the joint pin are respectively connected to wheel suspension components of a motor vehicle.

The invention also concerns the use of a locking ring for a ball joint having a housing with an inside space and a pin opening, whose inside space has in an area facing toward the pin opening an inner circumferential surface that surrounds an axial central longitudinal axis, a ball socket arranged in the inside space and open toward the pin opening, which socket has on its side that faces toward the pin opening an overlap area which is inclined inward relative to the central longitudinal axis in the direction of the pin opening and which, together with the inner circumferential surface of the housing, delimits an annular space, and a ball pin with a joint ball which with its joint ball is fitted into and can move in the ball socket whereas the pin extends through the pin opening and out of the housing, such that the locking ring is inserted into the annular space and is or comes to be held in position axially between the ball socket and an inner shoulder of the housing provided in the area of the pin opening, wherein the locking ring has an outer circumferential area in contact with the inner circumferential surface of the housing and a contact surface which is in contact with a contact zone of the overlap area of the ball socket and is inclined inward relative to the central longitudinal axis in the direction of the pin opening, and wherein the locking ring is or comes to be made as an open ring.

The use can be developed further in accordance with all the design features explained in connection with the ball joint. Furthermore, the ball joint can be developed further in accordance with all the design features explained in connection with the use.

Preferably the locking ring is inserted into the annular space with some pressure, so that it can even be said that the locking ring is pressed into the annular space. In particular, the locking ring is pressed and/or inserted under pressure into the annular space in the axial direction, until it is in contact with both the inner circumferential surface of the housing and also with the overlap area of the ball socket.

As the locking ring is inserted and/or pressed into the annular space, the ball socket in particular is deformed. This can result in an inhomogeneous stress distribution in the ball socket and hence to stiffness or jamming of the joint ball in the ball socket. Preferably, after the locking ring has been fitted between the ball socket and the inner shoulder of the housing, the ball socket is subjected to a tempering process. This can eliminate an inhomogeneous stress distribution in the ball socket.

In one version, when the locking ring is inserted and/or fixed in place, the ball socket is deformed so that the joint ball is gripped in the ball socket. Then the ball socket is subjected to a tempering treatment whereby the joint ball is released again and/or the gripping of the joint ball is relaxed again. In this way, in particular the ease of movement of the joint ball can be adjusted in a controlled manner.

The locking ring is axially fixed between the ball socket and the inner shoulder of the housing, in particular in that a rim of the housing (housing rim) is deformed inward and as a result of this deformation forms the inner shoulder. The deformation is carried out for example by rolling. Thus, the inner shoulder can also be called a rolled edge. Rolling is in particular understood to mean a deformation process in which the rim of the housing is bent inward by a roller under pressure. Alternatively however, the inner shoulder can be formed by a separate component which is or comes to be fixed to the housing. In particular, the inner shoulder extends all the way round.

### BRIEF DESCRIPTION OF THE DRAWINGS

Below, the invention is described with reference to preferred embodiments illustrated in the drawings, which show:

FIG. 1: A longitudinal section through a first embodiment of a ball joint,

FIG. 2: An enlarged view of the area marked A in FIG. 1,

FIG. 3: A perspective view of the locking ring shown in FIG. 1, seen in isolation,

FIG. 4: A longitudinal section through a second embodiment of a ball joint,

FIG. 5: An enlarged view of the area marked B in FIG. 4,

FIG. 6: A longitudinal section through a third embodiment of a ball joint, and

FIG. 7: An enlarged view of the area marked E in FIG. 6.

### DETAILED DESCRIPTION OF THE PREFERRED EMBODIMENTS

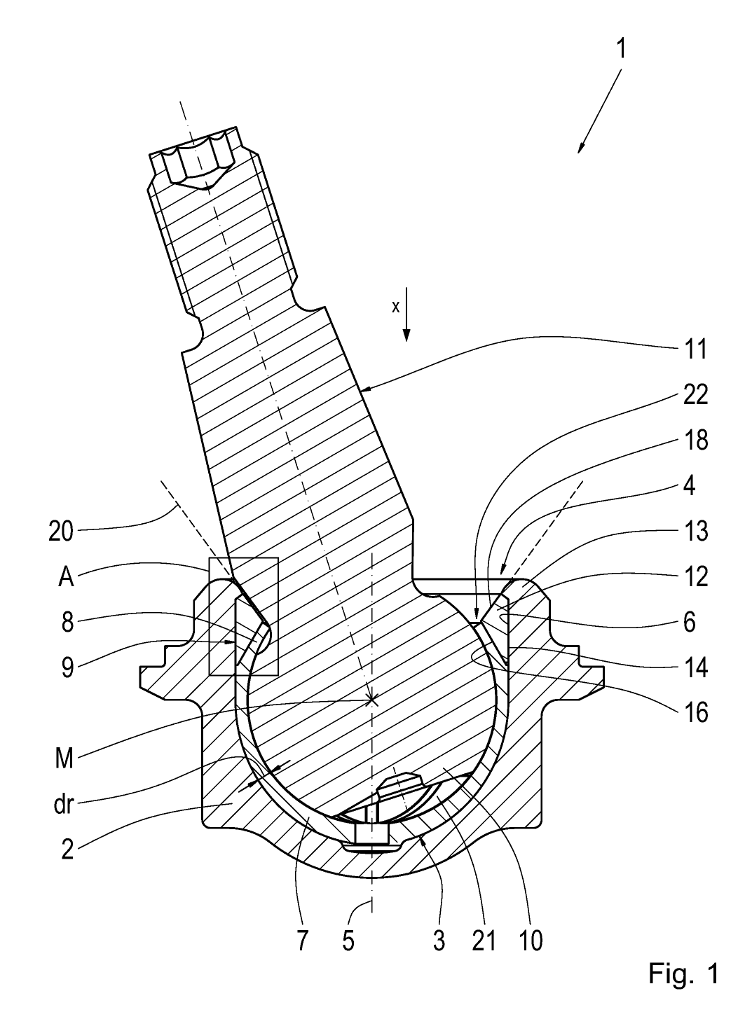

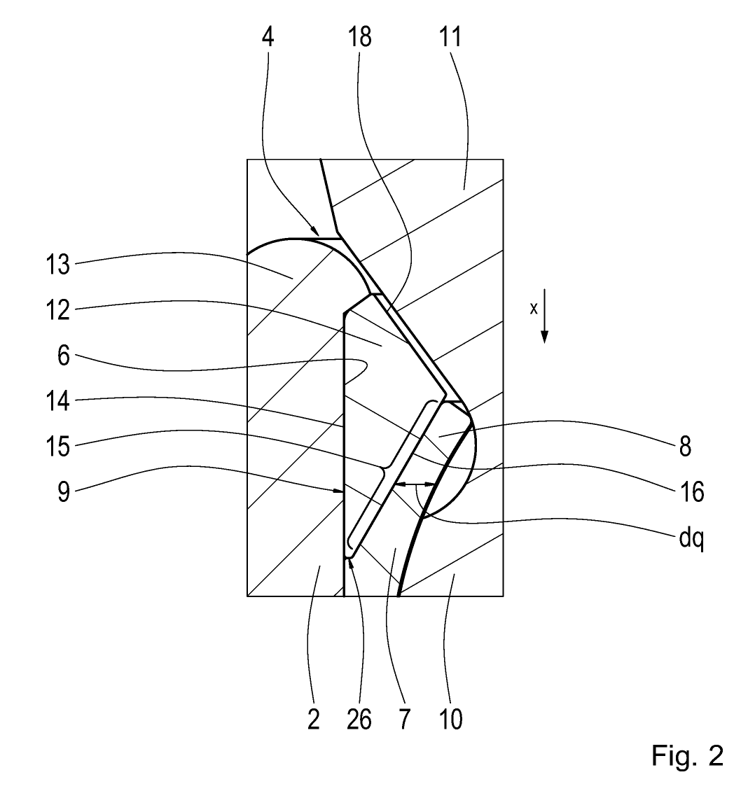

FIG. 1 shows a longitudinal section through a first embodiment of a ball joint 1, which comprises a housing 2 having an inside space 3 and a pin opening 4, wherein the inside space 3 has in an area facing toward the pin opening 4 a cylindrical inner circumferential surface 6 that extends around an axial central longitudinal axis 5. In the inside space 3 is arranged a ball socket 7 open toward the pin opening 4, which has on its side facing the pin opening 4 an overlap area 8 which in the direction of the pin opening 4 is inclined inward and which, together with the cylindrical inner circumferential surface 6 of the housing 2, delimits an annular space 9. Into the ball socket 7 is fitted a ball pin 11 with a joint ball 10, which joint ball 10 can move within the socket, the ball pin extending through the pin opening 4 out of the housing 2. An enlarged view of the area marked A in FIG. 1 is shown in FIG. 2. The axial direction in which the central longitudinal axis 5 extends is indexed x.

Into the annular space 9 is inserted a locking ring 12, which is held in position between the ball socket 7 and an inner shoulder 13 of the housing 2 formed in the area of the pin opening 4. In this case, on its side facing away from the pin opening 4 and particularly on its end side 26 remote from the pin opening 4, the locking ring 12 rests only against the ball socket 7 and not against the housing 2. Moreover, the locking ring 12 is pressed axially by the inner shoulder 13 against the ball socket 7, so that the latter is under some prestress. The locking ring 12 has a cylindrical outer circumferential surface 14 in contact with the cylindrical inner circumferential surface 6 of the housing 2, and a contact surface 16 inclined in the direction of the pin opening 4 inward toward the central longitudinal axis 5, which contact surface rests against a contact zone 15 of the overlap area 8 of the ball socket 7. Viewed in cross-section the surfaces 14 and 16 form a wedge seated in the annular space 9, and the cylindrical inner circumferential surface 6 of the housing 2 and the overlap area 8 of the ball socket 7 also give the annular space 9 a wedge shape as viewed in cross-section.

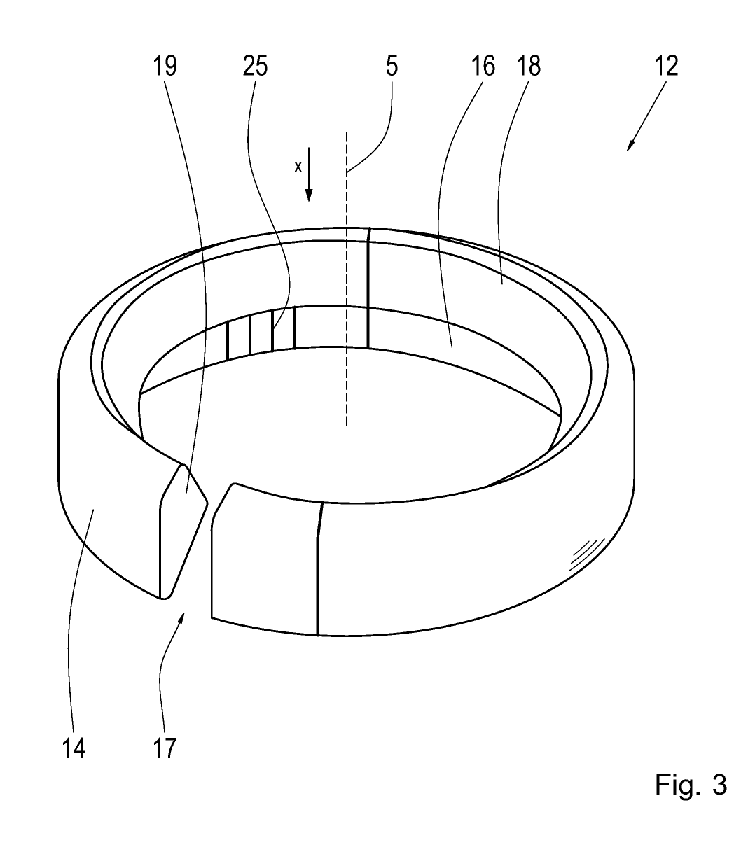

From FIG. 3, which shows the locking ring 12 in isolation, it can be seen that the locking ring 12 is in the form of an open ring having a parting gap 17 transverse to the central longitudinal axis 5, which gap can also be called a slit. In addition the locking ring 12 has a free opening surface 18 which faces toward the pin opening 4 and, in the direction of the pin opening 4, is inclined outward relative to the central longitudinal axis 5, which surface forms a stop for the ball pin 11. Thus, the locking ring 12 has an approximately triangular cross-sectional area 19 whose corners are rounded off. The inner shoulder 13 of the housing 2 formed by beading over a housing rim is in this case outside a solid angle or imaginary cone 20 defined by the opening surface 18 of the locking ring 12, which is indicated by broken lines in FIG. 2.

Furthermore, FIG. 3 also shows that on the contact surface 16 of the locking ring 12 a number of corrugations 25 are formed, which are indicated only schematically. Needless to say, around the central longitudinal axis 5 more corrugations than shown can be provided in the contact surface 16. Since the locking ring 12 is pressed against the ball socket 7, material of the ball socket 7 is pressed out into the corrugations 25 and this secures the ball socket 7 against twisting.

From FIG. 1 it can be seen that relative to the mid-point M of the joint ball 10, the radial thickness dr of the ball socket 7 decreases with decreasing axial distance from the pin opening 4. Furthermore, FIG. 2 shows that the thickness dq transversely to the central longitudinal axis 5 in the contact zone 15 is constant or approximately constant in the axial direction x. Thus, the ball joint 1 is designed in particular for principal loads in a direction transverse to the central longitudinal axis 5.

The ball socket 7 has a hollow ball-shaped bearing space 21 in which the joint ball 10 sits. In addition, in a part of the overlap area 8 of the ball socket 7 that faces toward the pin opening 4, a through-going aperture 22 is provided, through which the ball pin 11 extends out of the ball socket 7.

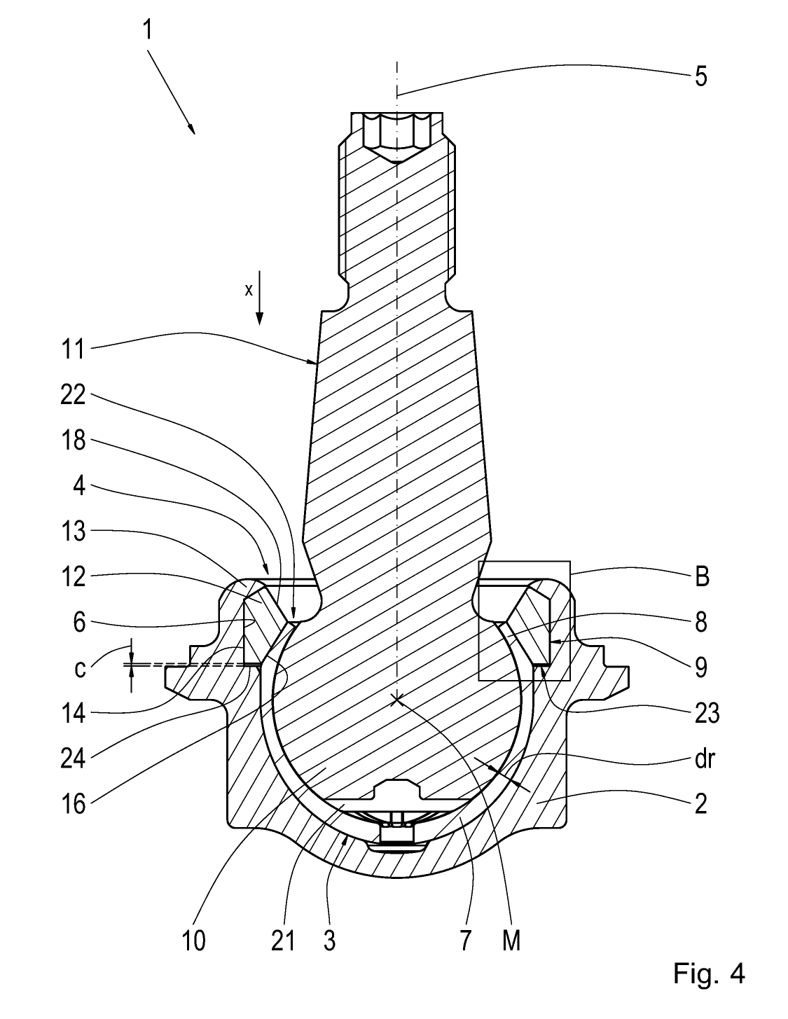

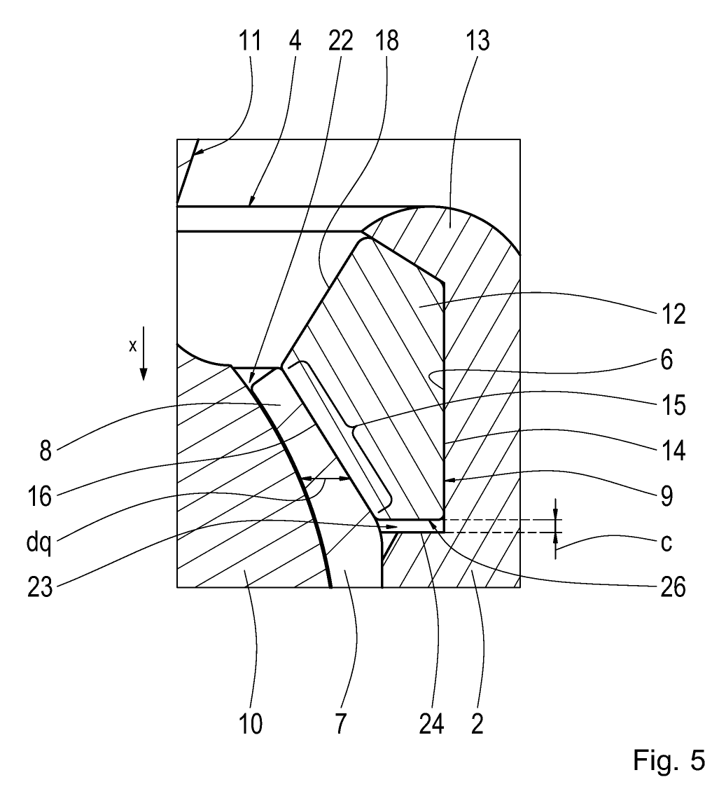

A longitudinal section through a second embodiment of a ball joint 1 is shown in FIG. 4, in which identical or similar features to those of the first embodiment are given the same indexes as for the first embodiment. Moreover, FIG. 5 shows an enlarged view of the area marked B in FIG. 4.

Otherwise than in the first embodiment, in an area facing toward the pin opening 4 the inside space 3 has an annular groove 23, in which the cylindrical inner circumferential surface 6 that surrounds the central longitudinal axis 5 is formed. The locking ring 12 sits in the annular groove 23 and is thicker in a direction transverse to the central longitudinal axis 5 than is the locking ring of the first embodiment, so that the cross-section of the locking ring 12 of the second embodiment is also no longer triangular or approximately so. However, on its end side 26 facing away from the pin opening 4 the locking ring 12 is an axial distance c away from a groove wall 24 of the annular groove 23 that faces away from the pin opening, so that on its side facing away from the pin opening 4 the locking ring 12 is supported axially only on the ball socket 7 but not on the housing 2. Apart from these differences the second embodiment corresponds with the first embodiment, so that for any further description of the second embodiment reference should be made to the description of the first embodiment.

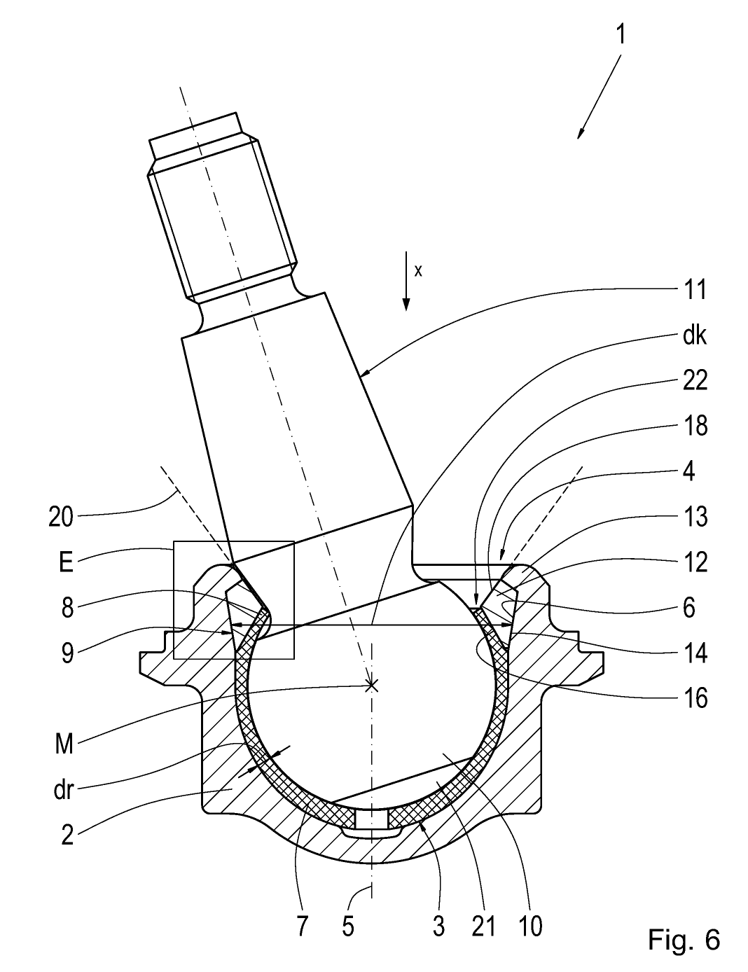

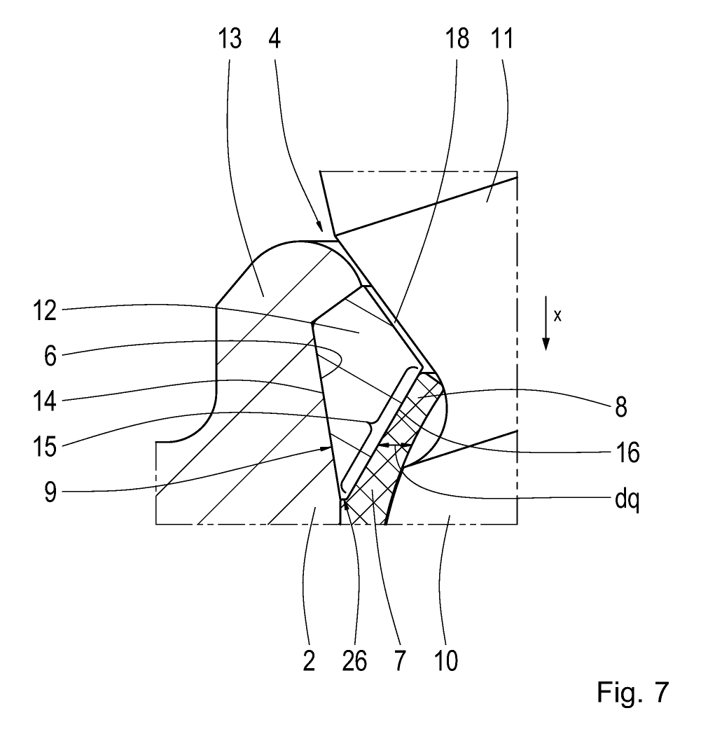

FIG. 6 shows a longitudinal section through a third embodiment of a ball joint 1, wherein features identical or similar to those of the first embodiment are indexed as for the first embodiment. In addition, FIG. 7 shows an enlarged view of the area marked E in FIG. 6.

The third embodiment is a deviation from the first embodiment, wherein otherwise than in the first embodiment, in its area facing toward the pin opening 4 the inside space 3 has a conical inner circumferential surface 6 extending around the central longitudinal axis 5. Moreover, the locking ring 12 has a conical outer circumferential surface 14 that rests in contact with the conical inner circumferential surface 6 of the housing 2. The conical surfaces 6 and 14 are designed such that in particular as viewed in the direction of the central longitudinal axis 5 and/or in the axial direction x, their diameter dk decreases with increasing distance from the pin opening 4 and/or the inner shoulder 13. Furthermore, in particular the inclination of the two conical surfaces relative to the central longitudinal axis 5 and/or the axial direction x is the same. By virtue of the conical shape of the inner circumferential surface 6 and the outer circumferential surface 14, although the housing 2 can with its inner circumferential surface 6 absorb axial forces from the locking ring 12, the locking ring 12, however, is not supported with its end 26 remote from the pin opening 4 directly against the housing 2, so that the locking ring 12 can always be pushed far enough into the annular space 9. Apart from these differences the third embodiment corresponds to the first embodiment, so that for any further description of the third embodiment reference should be made to the description of the first embodiment.

### INDEXES

1 Ball joint
2 Housing
3 Inside space of the housing
4 Pin opening of the housing
Central longitudinal axis
6 Inner circumferential surface of the housing
7 Ball socket
8 Overlap area of the ball socket
9 Annular space
10 Joint ball of the ball pin
11 Ball pin
12 Locking ring
13 Inner shoulder of the housing
14 Outer circumferential surface of the locking ring
15 Contact zone of the overlap area
16 Contact area of the locking ring
17 Parting gap of the locking ring
18 Opening surface of the locking ring
19 Cross-sectional area of the locking ring
20 Solid angle/cone
21 Hollow ball shaped fitting space for the ball socket
22 Through-going aperture of the ball socket
23 Annular groove
24 Groove wall of the annular groove
25 Corrugations
26 Axial end of the locking ring
c Distance
dr Radial thickness of the ball socket
dq Thickness of the ball socket transversely to the central longitudinal axis
dk Cone diameter
M Mid-point of the joint ball
x Axial direction

1-15. (canceled)

16. A ball joint comprising:
a housing (2) having an inside space (3) and a pin opening (4),
the inside space (3) of the housing having, in an area facing toward the pin opening (4), an inner circumferential surface (6) that extends around an axial central longitudinal axis (5),
a ball socket (7) being arranged in the inside space (3) of the housing and open toward the pin opening (4),
the ball socket having an overlap area (8) on a side facing toward the pin opening (4),
the overlap area, in a direction of the pin opening (4), being inclined inward relative to the central longitudinal axis (5) and, together with the inner circumferential surface (6) of the housing (2), delimits an annular space (9),
a ball pin (11) having a joint ball (10) being fitted and movable in the ball socket (7) and extending through the pin opening (4) out of the housing (2),
a locking ring (12) being inserted into the annular space (9) and being held in position, axially between the ball socket (7) and an inner shoulder (13) of the housing (2) provided in the area of the pin opening (4),
the locking ring having an outer circumferential surface (14) that rests against the inner circumferential surface (6) of the housing (2) and a contact surface (16) that rests in contact with a contact zone (15) of the overlap area (8) of the ball socket (7) and, in the direction of the pin opening (4), being inclined inward relative to the central longitudinal axis (5), and
the locking ring (12) being in a form of an open ring.

17. The ball joint according to claim 16, wherein the ball socket (7) is subjected to a tempering process after the locking ring (12) is fitted between the ball socket (7) and the inner shoulder (13) of the housing (2).

18. The ball joint according to claim 16, wherein a thickness profile of the ball socket (7) is selected such that, when the ball socket (7) is loaded in a principal load direction transverse to the central longitudinal axis (5), the load on the ball socket (7), in at least one of the overlap area (8) and the contact zone (15), is reduced.

19. The ball joint according to claim 16, wherein the ball socket (7) has either a constant or an approximately constant thickness, along the central longitudinal axis (5), in at least one of the overlap area (8) and the contact zone (15) in a principal loading direction.

20. The ball joint according to claim 16, wherein the ball socket (7), along the central longitudinal axis (5), has either a constant or an approximately constant thickness (dq) in the contact zone (15) transversely to the central longitudinal axis (5).

21. The ball joint according to claim 16, wherein a radial thickness (dr) of the ball socket (7), relative to a mid-point (M) of the joint ball (10), decreases with a decreasing axial distance from the pin opening (4).

22. The ball joint according to claim 16, wherein the locking ring (12) has a free opening surface (18) facing toward the pin opening (4) and inclined outward relative to the central longitudinal axis (5), in the direction of the pin opening (4).

23. The ball joint according to claim 22, wherein the inner shoulder (13) of the housing (2) lies outside either a solid angle or an imaginary cone (20) defined by the opening surface (18) of the locking ring (12).

24. The ball joint according to claim 16, wherein a cross section of the locking ring (12) is either wedge-shaped or triangular.

25. The ball joint according to claim 16, wherein the contact surface (16) of the locking ring (12) has corrugations (25) with which the ball socket (7) engages.

26. The ball joint according to claim 16, wherein the locking ring (12) is made from a wire profile.

27. The ball joint according to claim 16, wherein the locking ring (12) is axially spaced from the housing (2) on either a side or an end (26) facing away from the pin opening (4).

28. Use of a locking ring for a ball joint having a housing (3) with an inside space (3) and a pin opening (4), the inside space (3) of the housing having an inner circumferential surface (6) extending around an axial central longitudinal axis (5) in an area facing toward the pin opening (4), a ball socket (7) being arranged in the inside space (3) and open toward the pin opening (4), the ball socket having, on a side facing toward the pin opening (4), an overlap area (8) which, in a direction of the pin opening (4), is inclined inward relative to the central longitudinal axis (5) and which, together with the inner circumferential surface (6) of the housing (2), delimits an annular space (9), and a ball pin (11) having a joint ball (10), which with the joint ball (10) is fitted and movable in the ball socket (7) and which extends through the pin opening (4) out of the housing (2), a locking ring (12) being inserted into the annular space (9) and being held in position axially between the ball socket (7) and an inner shoulder (13) of the housing (2) provided in the area of the pin opening (4), and the locking ring (12) having an outer circumferential contact surface (14) resting against the inner circumferential surface (6) of the housing (2) and a contact surface (16) resting against a contact zone (15) of the overlap area (8) of the ball socket (7) and being inclined inward relative to the central longitudinal axis (5) in the direction of the pin opening (4), and the locking ring (12) being made as an open ring.

29. The use according to claim 28, wherein the ball socket (7) is subjected to a tempering process after the locking ring (12) is fitted between the ball socket (7) and the inner shoulder (13) of the housing (2).

30. The use according to claim 28, wherein when the locking ring (12) is at least one of inserted and fixed, the ball socket (7) is deformed such that the joint ball (10) is clamped in the ball socket (7), after which the ball socket (7) is subjected to a tempering process by which the clamping of the joint ball (10) is released again.

31. A ball joint comprising:
a housing having an inner circumferential surface extending around an axial central longitudinal axis and defining an open inside space;
a first axial end of the housing being closed, an opposite second axial end of the housing defining a pin opening;
the circumferential surface of the housing having an inner shoulder projecting radially inward toward the central longitudinal axis and being located adjacent the axial end of the housing having the pin opening;
a ball socket having an open axial end and being received within the inside space of the housing such that the open axial end of the ball socket faces the pin opening of the housing, the open axial end of the ball socket having an overlap area that is inclined radially inward toward the central longitudinal axis and together with the inner circumferential surface of the housing delimits an annular space;
a ball pin having a joint ball being movably received within the ball socket, and the ball pin extending axially through the open axial end of the ball socket and the pin opening out of the housing;
a locking ring being inserted into the annular space and fixed in position axially between the overlap area of the ball socket and the inner shoulder of the housing;
the locking ring having a radially outer facing circumferential surface that mates with the inner circumferential surface of the housing, and a radially inner facing contact surface abutting a contact zone of the overlap area of the ball socket and being inclined radially inward relative to the central longitudinal axis; and
the locking ring being an open ring.
